(19) United States
(12) Patent Application Publication
(10) Pub. No.: US 2015/0237153 A1
(43) Pub. Date: Aug. 20, 2015

(54) METHOD, DEVICE AND SYSTEM FOR PUSHING NETWORK DATA

(71) Applicant: TENCENT TECHNOLOGY (SHENZHEN) COMPANY LIMITED, Shenzhen (CN)

(72) Inventor: Xiaodan LIN, Shenzhen (CN)

(21) Appl. No.: 14/704,498

(22) Filed: May 5, 2015

Related U.S. Application Data
(63) Continuation of application No. PCT/CN2013/084336, filed on Sep. 26, 2013.

(30) Foreign Application Priority Data
Nov. 5, 2012 (CN) 201210436119.4

(51) Int. Cl. H04L 29/08

(52) U.S. Cl. CPC H04L 67/26; H04L 67/22

(57) ABSTRACT

Examples of the present disclosure provide a method, device and system for pushing network data. The method includes: a backend server obtains description information of a user attribute according to user data collected through an interaction with a user terminal; obtain network data matched with the description information of the user attribute, and pushing the network data to the user terminal. The technical solutions of the present disclosure may reduce the load of a backend server, and a user may get personalized data contents.

### CROSS REFERENCE TO RELATED APPLICATIONS

This application is a continuation of International Patent Application No. PCT/CN2013/084336, filed on Sep. 26, 2013, which claims the benefit of Chinese Patent Application No. 201210436119.4, filed on Nov. 05, 2012, the disclosures of both of said applications being herein incorporated by reference in their entirety.

### FIELD

The present disclosure relates to network technologies, and more particularly, to a method, device and system for pushing network data.

### BACKGROUND

The network data includes single text information and a variety of multimedia information. The multimedia information includes picture information, audio information and video information. At present, when interacting with user terminals, a backend server does not collect access data of the user terminals. Network data are pushed to all user terminals without distinguishing the users. Subsequently, the following problems may occur: the network data interaction and push technology may increase the load of the backend server since the interaction data amount is large and the data is pushed to all user terminals; and users cannot get personalized data content.

### SUMMARY

According to examples of the present disclosure, a method, device and system for pushing network data is provided to reduce the load of a backend server, and make a user get personalized data contents.

The method for pushing network data provided by an example of the present disclosure includes:

obtaining, by a backend server, description information of a user attribute according to user data collected through an interaction with a user terminal;

obtaining, by the backend server, network data matched with the description information of the user attribute, and pushing the network data to the user terminal

The device for pushing network data provided by an example of the present disclosure includes: a processor and a memory;

the memory is configured to store instructions;

the processor is configured to communicate with the memory and execute instructions stored in the memory to:

obtain description information of a user attribute according to user data collected through an interaction with a user terminal;

obtain network data matched with the description information of the user attribute ; and

push the network data to the user terminal.

The system for pushing network data provided by an example of the present disclosure includes:

a backend server, configured to obtain description information of a user attribute according to user data collected through an interaction with a user terminal; obtain network data matched with the description information of the user attribute, and

a push server, configured to obtain the network data from the backend server, and push the network data to the user terminal.

The system for pushing network data provided by an example of the present disclosure includes: a backend server and a user terminal;

the backend server is configured to obtain description information of a user attribute according to user data collected through an interaction with a user terminal, obtain network data matched with the description information of the user attribute, and push the network data to the user terminal;

the user terminal is configured to interact with the backend server, report the user data to the backend server, and receive the network data pushed by the backend server.

From the above technical solutions it can be seen that in the present disclosure, the backend server may obtain network data matched with description information of a user attribute obtained based on collected user data, and push the network data to a user terminal. Thus the data amount interacted between the backend server and user terminals may be decreased, and the load of the backend server may be reduced. The mode for pushing network data with special items to user terminals at preset time, i.e. the users may be distinguished according to description information of an attribute, and network data with different contents may be pushed to specific users. Thus the users may obtain personalized data contents.

### BRIEF DESCRIPTION OF THE DRAWINGS

Features of the present disclosure are illustrated by way of example and not limited in the following figures, in which like numerals indicate like elements, in which:

FIG. 1 is a flowchart illustrating a method for pushing network data according to an example of the present disclosure.

FIG. 2 is a schematic diagram illustrating a device for pushing network data according to an example of the present disclosure.

FIG. 3 is a schematic diagram illustrating a system for pushing network data according to an example of the present disclosure.

FIG. 4 is a schematic diagram illustrating a system for pushing network data according to an example of the present disclosure.

FIG. 5 is a schematic diagram illustrating a graphical interface displayed on a mobile phone according to an example of the present disclosure.

FIG. 6 is a schematic diagram illustrating a banner image of weather forecast based on user location information according to an example of the present disclosure.

FIG. 7 is a schematic diagram illustrating a graphical interface of a weather page according to an example of the present disclosure.

FIG. 8 is a schematic diagram illustrating a stock-market banner image based on a personalized customization according to an example of the present disclosure.

FIG. 9 is a schematic diagram illustrating a graphical interface of a stock market page according to an example of the present disclosure.

### DETAILED DESCRIPTION OF THE DRAWINGS

The present disclosure will be described in further detail hereinafter with reference to accompanying drawings and examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

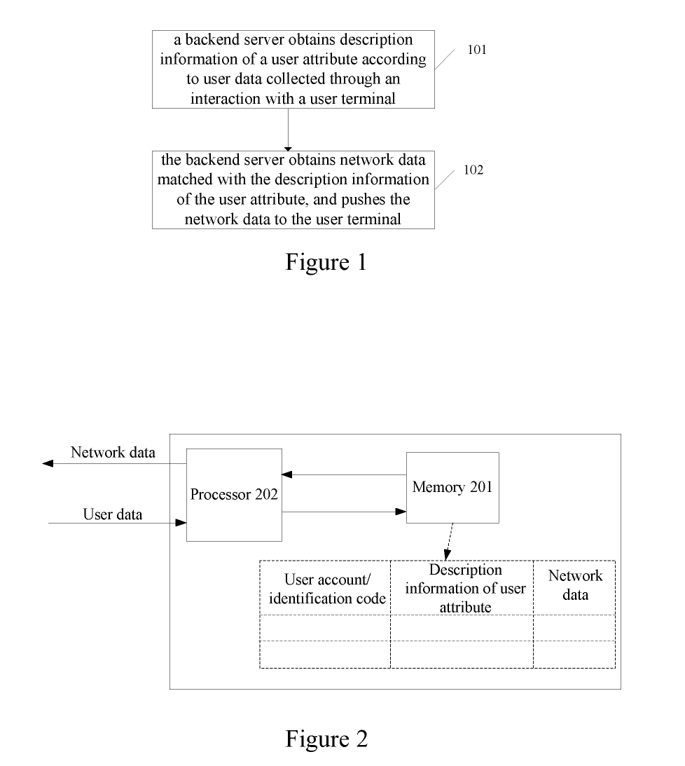

FIG. 1 is a flowchart illustrating a method for pushing network data according to an example of the present disclosure. As shown in FIG. 1, the method includes the following processes.

In block 101, a backend server obtains description information of a user attribute according to user data collected through an interaction with a user terminal.

In block 102, the backend server obtains network data matched with the description information of the user attribute, and pushes the network data to the user terminal

In the example of the present disclosure, because the backend server may collect matched user data regarding different users, obtain description information of a user attribute by analyzing the user data, obtain corresponding network data according to the description information of the user terminal, and push the obtained network data to the user terminal For example, the description information of the user attribute may be a user behavior. Thus after user data and user behaviors are continuously accumulated, personalized data contents are pushed to terminals, including terminals of a Mobile Application (App) and an internet user. The mode for pushing network data with special items to user terminals at preset time, i.e. the users may be distinguished according to description information of an attribute, and network data with different contents may be pushed to different users, reduces the data amount interacted between the backend server and user terminals, thereby reducing the load of the backend server.

Based on the technical solutions described in blocks 101 and 102, the description information of a user attribute is obtained according to user data collected through an interaction between a backend server and a user terminal in block 101 may include any one mode of the followings.

A first mode may be as follows. Description information of a user attribute is obtained after user data is collected based on a user account. The user account may be a login name of an Instant Messaging (IM) tool, a login name of a website, or the like.

A second mode may be as follows. Description information of a user attribute is obtained after user data is collected based on an identification code. The identification code may be an IP address, a MAC address, an International Mobile Subscriber Identification Number (IMSI), a mobile network Code (MNC), or the like. What should be noted may be as follows. 1) The IP address is a logical address. When a user browses a website, an IP address used by the user may be locked, and according to the IP address, the network position of the user may be known, therefore, user data of the user may be collected through the IP address. 2) Different from the IP address, the MAC address is a hardware address, or called a physical address. The MAC address is solidified in a network card of a terminal. One network card has one globally unique MAC address, while may correspond to multiple IP addresses. Because the MAC address stores an address for identifying a terminal, e.g. a computer, sending data and a terminal, e.g. a host, receiving data during the data transmission, according to the MAC address, a physical address used by a user may be known, thus user data of the user may be collected through the MAC address. 3) IMSI is a symbol for distinguishing mobile user terminals and is stored in a Subscriber Identity Module (SIM) card. The IMSI may be used as valid information for distinguishing mobile users. Since the IMSI is designed to uniquely identify an international mobile user, the country, region and network where the user is located may be distinguished, thus user data of the user may be collected through the IMSI. 4) Mobile communication networks include a variety of networks. The MNC is used to identify a mobile user in a mobile communication network, thus user data of the user may be collected through the MNC. In a word, all of the above identification codes are capable of identifying the users. Therefore, any of the above identification codes may be used to identify users, and user data may be collected according to any of the above identification codes.

In the first mode, the user data is collected based on a user account may include the followings. When a use logs on using a user account, a backend server collects user data of the user from a user terminal of the user based on the user account. After continuously collecting the user data, the backed server analyzes the user data collected based on the user account, and subsequently obtains description information of a user attribute.

The description information of a user attribute may include at least one kind of information of basic attribute information, social attribute information and behavioral attribute information. The basic attribute information may refer to an attribute representing basic identity information of a user, such as, name, age, gender, occupation and graduation year. The social attribute information may refer to a community attribute gained in a social network site, such as, a growth level, a title, a virtual function and a role. The behavioral attribute information may refer to an implicitly-derived attribute, which is formed by analyzing and intelligently mining the traces left by the user during activities in a long period of time in a social network site. The behavioral attribute information may also be known as a commercial-preference attribute having a statistical significance.

Correspondingly, the block 102 may include the followings. A mapping relationship among a user account, description information of a user attribute and network data is stored in the backend server. Network data matched with the description information of the user attribute is obtained according to the mapping relationship, and the obtained network data is pushed to a user terminal of a user using the user account. It should be noted that the mapping relationship includes but is not limited to a relational table.

Different from the first mode, in the second mode, it is not necessary for a user to log on with a user account. A user may be identified and recognized through an identification code. A backend server may collect user data from a user terminal based on the identification code, and analyze user data continuously collected based on the identification code to obtain description information of a user attribute.

The description information of a user attribute may include at least one kind of information of basic attribute information, social attribute information and behavioral attribute information. The basic attribute information may refer to an attribute representing basic identity information of a user, such as, name, age, gender, occupation and graduation year. The social attribute information may refer to a community attribute gained in a social network site, such as, a growth level, a title, a virtual function and a role. The behavioral attribute information may refer to an implicitly-derived attribute, which is formed by analyzing and intelligently mining the traces left by the user during activities in a long period of time in a social network site. The behavioral attribute information may also be known as a commercial-preference attribute having a statistical significance.

Correspondingly, the block 102 may include the followings. A mapping relationship among an identification code, description information of a user attribute and network data is stored in the backend server. Network data matched with the description information of the user attribute is obtained according to the mapping relationship, and the obtained network data is pushed to a user terminal with the identification code. It should be noted that the mapping relationship includes but is not limited to a relational table.

FIG. 2 is a schematic diagram illustrating a device for pushing network data according to an example of the present disclosure. The device includes a memory 201 and a processor 202 in communication with the memory 201.

The memory 201 may store a group of instructions which may be executed by the process 202 to obtain description information of a user attribute according to user data collected through an interaction with a user terminal; obtain network data matched with the description information of the user attribute, and push the network data to the user terminal.

According to an example, the memory 201 may further store a mapping relationship among a user account/an identification code, description information of a user attribute and network data. Instructions stored in the memory 201 may be executed by the processor 202 to obtain matched network data through description information of the user attribute according to the mapping relationship.

For example, the device may be configured to collected user data based on a user account. Correspondingly, the memory 201 may store a mapping relationship among a user account, description information of a user attribute and network data. Instructions stored in the memory 201 may be executed by the processor 202 to obtain network data matched with the description information of the user attribute according to the mapping relationship, and push the obtained network data to a user terminal of a user with the user account.

For example, the device may be configured to collected user data based on an identification code. Correspondingly, the memory 201 may store a mapping relationship among an identification code, description information of a user attribute and network data. Instructions stored in the memory 201 may be executed by the processor 202 to obtain network data matched with the description information of the user attribute according to the mapping relationship, and push the obtained network data to a user terminal with the identification code.

According to an example, the device may be a backed server.

According to an example, the user terminal includes at least one of a mobile terminal and a Personal Computer (PC) terminal. The device may be a cloud storage system adopting a cloud storage technology.

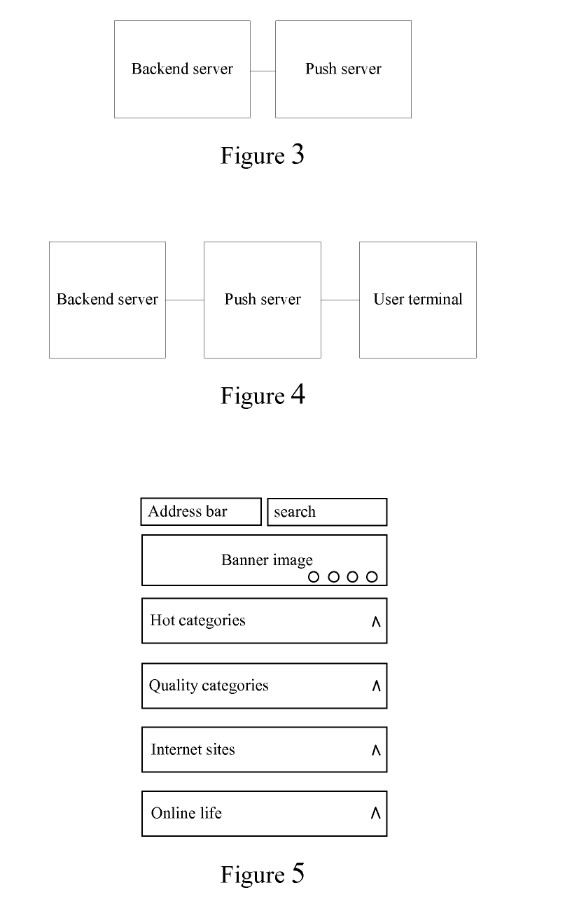

FIG. 3 is a schematic diagram illustrating a system for pushing network data according to an example of the present disclosure. The system includes a backend server and a push server. The backend server is configured to obtain description information of a user attribute according to user data collected through an interaction with a user terminal; obtain network data matched with the description information of the user attribute. The push server is configured to obtain the matched network data from the backend server, and push the matched network data to the user terminal adopting a push mechanism.

According to an example, the user terminal includes at least one of a mobile terminal and a Personal Computer (PC) terminal. The backend server may be a cloud storage system adopting a cloud storage technology. The backend server may store a mapping relationship among a user account/an identification code, description information of a user attribute and network data, so as to obtain matched network data through description information of the user attribute according to the mapping relationship. It should be noted that the mapping relationship includes but is not limited to a relational table. Pushed network data includes but is not limited to weather and meteorological data, text reading data, advertising data, financial investment data including stock market data and futures data, activity data of social network sites.

For example, the backend server may be configured to collected user data based on a user account. Correspondingly, the backend server may store a mapping relationship among a user account, description information of a user attribute and matched network data, obtain network data matched with the description information of the user attribute according to the mapping relationship, and the matched network data may be pushed to a user terminal of a user with the user account.

For example, the backend server may be configured to collected user data based on an identification code. Correspondingly, the backend server may store a mapping relationship among an identification code, description information of a user attribute and matched network data, obtain network data matched with the description information of the user attribute according to the mapping relationship, and the matched network data may be pushed to a user terminal with the identification code.

FIG. 4 is a schematic diagram illustrating a system for pushing network data according to an example of the present disclosure. The system includes a backend server and a user terminal. The backend server is configured to obtain description information of a user attribute according to user data collected through an interaction with a user terminal, obtain network data matched with the description information of the user attribute, and push the network data to the user terminal The user terminal is configured to interact with the backend server, report the user data to the backend server, and receive the network data pushed by the backend server.

According to an example, the user terminal may send the user data to the backend server when a user logs on with a user account, and the backend server may collect the user data based on the user account during the interaction with the user terminal.

The backend server may further store a mapping relationship among a user account, description information of a user attribute and matched network data. After obtaining the description information of a user attribute according to collected user data, the backend server may obtain network data matched with the description information of the user attribute according to the mapping relationship, and push the matched network data to a user terminal of a user with the user account.

According to an example, the user terminal may indicate the user data with an identification code, and send the user data indicated by the identification code to the backend server, and the backend server may collect the user data based on the identification code during the interaction with the user terminal

The backend server may further store a mapping relationship among an identification code, description information of a user attribute and matched network data. After obtaining the description information of a user attribute according to collected user data, the backend server may obtain network data matched with the description information of the user attribute according to the mapping relationship, and push the network data to a user terminal with the identification code. The identification code includes at least one of an IP address, a MAC address, an IMSI and a mobile network code.

According to an example, the system may further include a push server which may be located between the backend server and the user terminal. The push server is connected with the backend server. The push server is configured to obtain the matched network data from the backend server, and push the matched network data to the user terminal adopting a push mechanism.

Based on an application example, when a user terminal is a mobile phone, after the user terminal obtains network data pushed by a backend server, a variety of graphical interfaces presented statically or in a manner of dynamic rolling broadcast may be displayed on the mobile phone. The graphical interfaces may be displayed in a prominent location of the mobile phone in the form of a banner image. The banner image refers to a bar picture located in the top, middle, bottom or other prominent locations of a webpage or a start page of a user terminal. The banner image may transversely across throughout or more than half of the page.

An application of a browser on the mobile phone is taken as an example. As shown in FIG. 5, the banner image is displayed in the top of the start page (below the address bar and above the drawer navigation) of the browser. The banner image may be showed in fixed or carousel form. The backend server may push diversified and personalized banner images, such as a banner image of weather forecast based on user location information, a stock-market banner image based on a personalized customization, a banner image of user birthday care, an operation banner image of sending ordered information to a specific user. The banner images will be cited with reference to examples hereinafter.

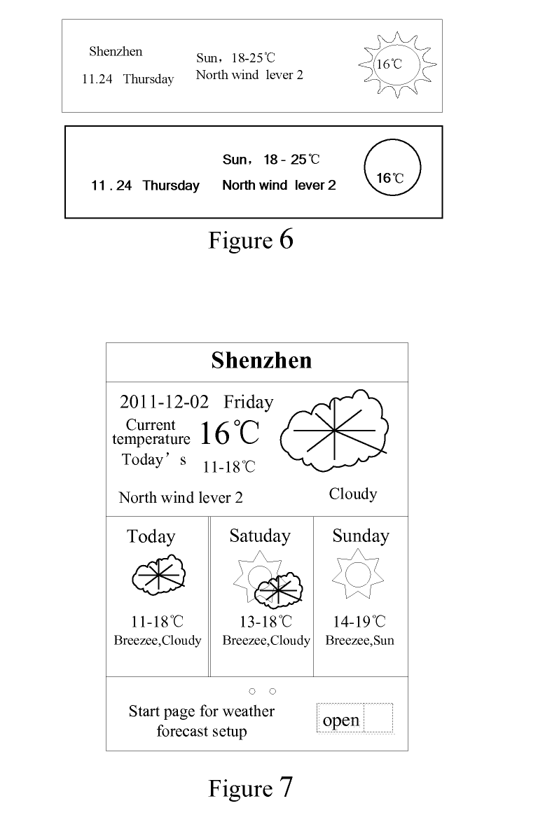

The banner image of weather forecast based on user location information according to an example is shown in FIG. 6. As an important information source of users, the weather banner image is for all users. It is necessary, however, to include personalized location information of a user in the weather banner image. In the example, the preset background images include a day image and a night image. The location information of the user is determined through a gateway IP address by default, and the location information is transmitted to a backend device. The backend device calls a weather interface, and obtains weather information of the location of the user. The weather data during a period of time of the location of the user is pushed by a backend server to the mobile phone of the user. A banner image showing current date, a city where the user is located, weather data and weather image of the city is displayed on the mobile phone. The weather banner image may be an image having a link, through which a weather details page may be linked to. The weather details page is shown in FIG. 7.

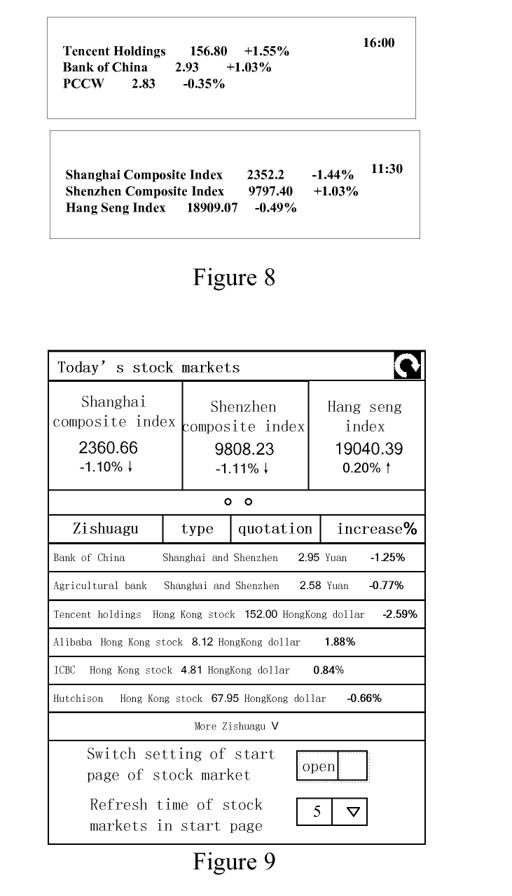

The stock-market banner image based on a personalized customization according to an example is shown in FIG. 8. Different users have different preferences towards contents, such as stock quotes. The target user of the personalized stock information banner image may be a user who selects the stock in the QQ stock on a QQ panel of a PC terminal. The banner image is not shown to all users, and only a user who subscribes a Zishuagu may receive the banner image. A QQ browser, according to login information of a user, accesses a backend server to search for a user image corresponding to a user account of the user, and determines whether the user subscribed stock information and whether the user is a stock lover, if yes, pushes the latest stock information to the user. Therefore, the banner image may show the latest Zishuagu and Large-cap stocks, the information of the Zishuagu and Large-cap stocks may be refreshed within a predetermined period. The stock-market banner image may have a link, through which a stock-market details page may be linked to. The stock-market details page is shown in FIG. 9.

The foregoing description is only preferred embodiments of the present disclosure and is not used for limiting the protection scope thereof Any modification, equivalent substitution, or improvement made without departing from the spirit and principle of the present disclosure should be covered by the protection scope of the present disclosure.

What is claimed is:

1. A method for pushing network data, comprising:
obtaining, by a backend server, description information of a user attribute according to user data collected through an interaction with a user terminal;
obtaining, by the backend server, network data matched with the description information of the user attribute, and pushing the network data to the user terminal

2. The method according to claim 1, wherein the user data is collected base on a user account.

3. The method according to claim 2, wherein the user data is collected base on a user account comprises:
when a user logs on with a user account, collecting, by the backend server, the user data based on the user account.

4. The method according to claim 3, wherein obtaining, by the backend server, network data matched with the description information of the user attribute, and pushing the network data to the user terminal, comprise:
storing, by the backend server, a mapping relationship among a user account, description information of a user attribute and network data;
obtaining, by the backend server, network data matched with the description information of the user attribute according to the mapping relationship;
pushing, by the backend server, the network data to the user terminal of a user with the user account.

5. The method according to claim 1, wherein the user data is collected base on an identification code.

6. The method according to claim 5, wherein the identification code comprises at least one of the followings: an IP address, a MAC address, an International Mobile Subscriber Identification Number, and a mobile network Code.

7. The method according to claim 6, wherein obtaining, by the backend server, network data matched with the description information of the user attribute, and pushing the network data to the user terminal comprises:
storing, by the backend server, a mapping relationship among an identification code, description information of a user attribute and network data;
obtaining, by the backend server, network data matched with the description information of the user attribute according to the mapping relationship;
pushing, by the backend server, the network data to the user terminal with the identification code.

8. A device for pushing network data, comprising: a processor and a memory; wherein,
the memory is to store instructions;
the processor is to communicate with the memory and execute instructions stored in the memory to:
obtain description information of a user attribute according to user data collected through an interaction with a user terminal;
obtain network data matched with the description information of the user attribute ; and
push the network data to the user terminal.

9. The device according to claim 8, wherein the processor is further to execute instructions stored in the memory to:
collect the user data based on a user account.

10. The device according to claim 9, wherein the memory is further to store a mapping relationship among a user account, description information of a user attribute and network data;
the processor is to execute instructions stored in the memory to:
obtain network data matched with the description information of the user attribute according to the mapping relationship; and
push the network data to a user terminal of a user with the user account.

11. The device according to claim 8, wherein the processor is further to execute instructions stored in the memory to:
collect the user data based on an identification code.

12. The device according to claim 11, wherein the memory is further to store a mapping relationship among an identification code, description information of a user attribute and network data;
the processor is to execute instructions stored in the memory to:
obtain network data matched with the description information of the user attribute according to the mapping relationship; and
push the network data to a user terminal with the identification code.

13. A system for pushing network data, comprising:
a backend server, to obtain description information of a user attribute according to user data collected through an interaction with a user terminal; obtain network data matched with the description information of the user attribute, and
a push server, to obtain the network data from the backend server, and push the network data to the user terminal

14. The system according to claim 13, wherein the backend server is further to collect the user data based on a user account.

15. The system according to claim 14, the backend server is further to store a mapping relationship among a user account, description information of a user attribute and network data; obtain network data matched with the description information of the user attribute according to the mapping relationship, and the network data is pushed to a user terminal of a user with the user account.

16. The system according to claim 13, the backend server is further to collect the user data based on an identification code.

17. The system according to claim 16, the backend server is further to store a mapping relationship among an identification code, description information of a user attribute and network data; obtain network data matched with the description information of the user attribute according to the mapping relationship, and the network data is pushed to a user terminal of with the identification code.

18. The system according to claim 13, further comprising: a user terminal; wherein
the user terminal is to interact with the backend server, report the user data to the backend server, and receive the network data pushed by the push server.

19. The system according to claim 18, wherein the user terminal is further to report the user data to the backend server when a user logs on with a user account; and
the backend server is further to collect the user data based on the user account.

20. The system according to claim 18, wherein the user terminal is further to indicate the user data with an identification code, and report the user data indicated by the identification code to the backend server; and
the backend server is further to collect the user data based on the identification code.
